(19) United States
(12) Patent Application Publication
(10) Pub. No.: US 2007/0217047 A1
(43) Pub. Date: Sep. 20, 2007

(54) Master medium for perpendicular magnetic transfer, method of perpendicular magnetic transfer, perpendicular magnetic recording medium and perpendicular magnetic recording apparatus

(75) Inventors: Kenji Ichikawa, Odawara-shi (JP); Toshihiro Usa, Odawara-shi (JP); Kazuhiro Niitsuma, Odawara-shi (JP); Tadashi Yasunaga, Odawara-shi (JP); Sumio Kuroda, Kawasaki-shi (JP); Tsugito Maruyama, Kawasaki-shi (JP)

Correspondence Address: SUGHRUE MION, PLLC, 2100 PENNSYLVANIA AVENUE, N.W., SUITE 800, WASHINGTON, DC, 20037, US

(73) Assignees: FUJIFILM Corporation, Tokyo (JP); FUJITSU LIMITED, Kawasaki-shi (JP)

(21) Appl. No.: 11/716,007

(22) Filed: Mar. 9, 2007

(30) Foreign Application Priority Data
Mar. 9, 2006 (JP) 2006-064732

(51) Int. Cl. G11B 5/86; G11B 5/82

(52) U.S. Cl. 360/17; 360/135

(57) ABSTRACT

An aspect of the present invention provides a master medium for perpendicular magnetic transfer, comprising: a disk-like substrate on a surface of which a plurality of protruding magnetic-layer patterns corresponding to information to be transferred to a magnetic recording medium targeted for transfer are formed. In the master medium for perpendicular magnetic transfer, a ratio of a circumferential width L of the protruding magnetic-layer patterns to a circumferential gap S between the protruding magnetic-layer patterns is L/S<1. According to the aspect of the present invention, good magnetic transfer can be performed and, therefore, a perpendicular magnetic recording medium (a slave disk) that is free from defects and has a good C/N ratio can be obtained. In addition, it is possible to perform good magnetic transfer.

### BACKGROUND OF THE INVENTION

1. Field of the Invention

The present invention relates to a master medium for perpendicular magnetic transfer, a method of perpendicular magnetic transfer, a perpendicular magnetic recording medium and a perpendicular magnetic recording apparatus. More particularly, the invention relates to a master medium for perpendicular magnetic transfer suitable for the perpendicular magnetic transfer of a magnetic information pattern, such as format information, to a magnetic disk used in a hard disk device and the like, a method of perpendicular magnetic transfer that uses this master medium, a perpendicular magnetic recording medium on which magnetic transfer is performed by this method of perpendicular magnetic transfer, and a perpendicular magnetic recording apparatus provided with this perpendicular magnetic recording medium.

2. Description of the Related Art

For magnetic disks (hard disks) used in hard disk drives that have rapidly come into widespread use, it is general practice that format information and address information are written before the incorporation of these magnetic disks (hard disks) into drives after their deliveries from magnetic disk makers to drive makers. Although this writing can also be performed by a magnetic head, a method based on batch transfer from a master disk on which these format information and address information are written is efficient and hence preferable.

In this magnetic transfer technology, with a master disk and a disk targeted for transfer (a slave disk) brought into close contact with each other, a magnetic field generating device, such as an electromagnet device and a permanent magnet device, is disposed on one side or both sides and magnetic fields for transfer are applied, whereby the transfer of magnetization patterns corresponding to information (for example, a servo signal) that the master disk has is performed.

For such magnetic transfer, various kinds of constructions and methods have hitherto been proposed (for example, refer to Japanese Patent Application Laid-Open No. 2004-87099, Japanese Patent Application Laid-Open No. 10-40544, and Japanese Patent Application Laid-Open No. 45024; U.S. Pat. No. 6,906,876 corresponds to Japanese Patent Application Laid-Open No. 45024). The proposal of Japanese Patent Application Laid-Open No. 2004-87099 relates to a device that holds master disks by use of a pair of holder units, supplies a slave disk to between the pair of master disks by use of a robot hand, and applies thereafter magnetic fields for transfer to both surfaces of the slave disk, with the slave disk brought into pressure contact with the master disks and supported in a sandwiched manner.

The proposal of Japanese Patent Application Laid-Open No. 10-40544 relates to a method of applying magnetic fields for transfer, with a master disk, in which concave-convex shapes corresponding to information signals are formed on a surface of a substrate and at least convexity surfaces are formed by a ferromagnetic material, brought into pressure contact with a slave disk.

Incidentally, magnetic recording media are divided into an in-plane magnetic recording medium having an axis of easy magnetization in a plane of a magnetic layer of the magnetic recording medium and a perpendicular magnetic recording medium having an axis of easy magnetization in a direction perpendicular to a plane of a magnetic layer. In general, the in-plane magnetic recording medium has hitherto been used.

On the other hand, the development of perpendicular magnetic recording media and methods of perpendicular magnetic recording, from which a substantial improvement in recording density (an increase in storage capacity) can be expected, have been in process and large-scale introduction of such perpendicular magnetic recording media and methods of perpendicular magnetic recording in markets in the near future is called for.

Therefore, also for the above-described magnetic transfer, constructions corresponding to perpendicular magnetic recording are sought for. That is, the above-described development of magnetic transfer techniques is carried out, with an eye to magnetic transfer solely to in-plane magnetic recording media, and the development of magnetic transfer techniques capable of being applied to perpendicular magnetic recording is sought for.

### SUMMARY OF THE INVENTION

However, in performing magnetic transfer to a perpendicular magnetic recording medium, it is necessary to apply a magnetic field in a direction perpendicular to a plane of a magnetic layer and conditions different from those in in-plane magnetic recording are sought for. At the same time, magnetic transfer to a perpendicular magnetic recording medium has problems inherent in it.

For example, the ratio of the circumferential width L of protruding magnetic-layer patterns of a master disk used in the magnetic transfer of an in-plane magnetic recording medium and the circumferential gap S between the protruding magnetic-layer patterns, L/S, is often set at not less than 1. However, it has been ascertained by the present inventors that when a master disk of such L/S ratio is used in the magnetic transfer to a perpendicular magnetic recording medium, problems as described below occur.

FIGS. 17A and 17B are partially enlarged views that show protruding magnetic-layer patterns of a master disk. As shown in FIG. 17A, lands (L) and spaces (S) of protruding patterns are alternately formed on a surface of the master disk. And in the case of a master disk for in-plane magnetic recording, as shown in FIG. 17B, protruding patterns are often formed to provide L/S ratios of not less than 1.

However, when perpendicular magnetic recording is performed by using a master disk having an L/S ratio as shown in FIG. 17B, regenerative signals often become defective. FIGS. 18A to 18C are graphs that show regenerative signals of a slave disk when perpendicular magnetic recording is performed by using a master disk having an L/S ratio as shown in FIG. 17B. Among these figures, FIG. 18A shows regenerative signals in an MD portion (a middle circumferential portion) of the slave disk and FIG. 18C shows regenerative signals in an ID portion (an inner circumferential portion) of the slave disk. And FIG. 18B is a graph that shows an enlarged scale of a pattern having a wavelength twice the wavelength of FIG. 18A.

As can be seen from each of the graphs of FIGS. 18A to 18C, it has been ascertained by the present inventors that when a master disk having an L/S ratio as shown in FIG. 17B is used, three kinds of problems as described below occur.

1) In a pattern having a long wavelength p (=1/f, f: frequency) (particularly, in an OD portion (an outer circumferential portion)), an irregularity occurs at the front of the waveform as shown in FIG. 18B (two peaks).

2) The signal intensity transferred in a pattern portion of a fundamental frequency F has large variation values. That is, as shown in FIG. 18A, the modulation is large and particularly, as shown in FIG. 18C, the modulation is large in an inner circumferential portion.

3) As shown in FIG. 18C, in an inner circumferential portion (when the frequency f increases), the signal intensity decreases remarkably.

The present invention has been made in view of such circumstances and has as its object the provision of a master medium for perpendicular magnetic transfer, a method of perpendicular magnetic transfer that uses the master medium, a perpendicular magnetic recording medium on which magnetic transfer is performed by the method of perpendicular magnetic transfer, and a perpendicular magnetic recording apparatus provided with the perpendicular magnetic recording medium that can ensure a stable signal C/N ratio on the whole surface of a transfer medium, can suppress phenomena specific to perpendicular magnetic recording (each of the above-described problems), and can consequently perform good magnetic transfer to the perpendicular magnetic recording medium.

To achieve the above-described object, a first aspect of the present invention provides a master medium for perpendicular magnetic transfer, comprising: a disk-like substrate on a surface of which a plurality of protruding magnetic-layer patterns corresponding to information to be transferred to a magnetic recording medium targeted for transfer are formed, wherein a ratio of a circumferential width L of the protruding magnetic-layer patterns to a circumferential gap S between the protruding magnetic-layer patterns is L/S<1.

By repeating various kinds of examinations, the present inventors have found out that by ensuring that the ratio of the circumferential width L of the protruding magnetic-layer patterns to the circumferential gap S between the protruding magnetic-layer patterns, L/S, is less than 1, it is possible to ensure a stable signal C/N ratio on the whole surface of a transfer medium, to suppress phenomena specific to perpendicular magnetic recording (each of the above-described problems), and consequently to perform good magnetic transfer to the perpendicular magnetic recording medium.

That is, the present inventors have found out that by appropriately arranging and controlling the magnetic field intensity applied to pattern edges of the protruding magnetic-layer patterns, it is possible to maintain a difference between an initialized condition and a saturated recording condition and to obtain a stable recording condition. The details will be described later.

Also, to achieve the above-described object, a second aspect of the present invention provides a master medium for perpendicular magnetic transfer, comprising: a disk-like substrate on a surface of which a plurality of protruding magnetic-layer patterns corresponding to information to be transferred to a magnetic recording medium targeted for transfer are formed, wherein a relation of the circumferential width L of the protruding magnetic-layer patterns to a fundamental frequency f of an information to be transferred is expressed by L=305−302·Exp(−1/(700·f)) and the ratio of the width L to the circumferential gap S between the protruding magnetic-layer patterns is (⅓)≦L/S<1.

By similarly repeating various kinds of examinations, the present inventors have found out that by ensuring that the relation of the circumferential width L of the protruding magnetic-layer patterns to the fundamental frequency f of the information to be transferred is expressed by L=305−302·Exp(−1/(700·f)) and that the ratio of the width L to the circumferential gap S between the protruding magnetic-layer patterns is (⅓)≦L/S<1, it is possible to ensure a stable signal C/N ratio on the whole surface of a transfer medium, to suppress phenomena specific to perpendicular magnetic recording (each of the above-described problems), and consequently to perform good magnetic transfer to the perpendicular magnetic recording medium. The details also will be described later.

In the first or second aspect of the present invention, it is preferred that the master medium for perpendicular magnetic transfer be formed so as to provide different values of the ratio L/S according to the frequency of the information to be transferred in the same radial position of the substrate. If the master medium for perpendicular magnetic transfer can be formed so as to provide optimum values of the ratio L/S according to the frequency, it is possible to perform still better magnetic transfer.

Also, a third aspect of the present invention provides a method of perpendicular magnetic transfer that comprises: a close contacting step of bringing the master medium for perpendicular magnetic transfer into close contact with the magnetic recording medium targeted for transfer; and a magnetic transfer step of providing a magnetic field generating device, applying magnetic fields perpendicular to surfaces of the magnetic recording medium targeted for transfer and of the master medium for perpendicular magnetic transfer, and causing the magnetic patterns of the master medium for perpendicular magnetic transfer to be transferred to the magnetic recording medium targeted for transfer.

According to the present invention, good magnetic transfer as described above can be performed and, therefore, a perpendicular magnetic recording medium (a slave disk) that is free from defects and has a good C/N ratio can be obtained.

As described above, according to the present invention, it is possible to perform good magnetic transfer.

### BRIEF DESCRIPTION OF THE DRAWINGS

FIG. 1 is a plan view of a master disk for perpendicular magnetic transfer related to the present invention;

FIG. 2 is a partially enlarged perspective view that shows fine concavo-convex patterns on a surface of a master disk;

FIGS. 3A to 3D are sectional views to explain a method of forming a master disk;

FIG. 4 is a partial front view of a magnetic transfer apparatus;

FIG. 5 is a perspective view to explain an outline of a method of magnetic transfer;

FIGS. 6A to 6C are sectional views to explain basic steps of magnetic transfer;

FIGS. 7A to 7C are partially enlarged views that show protruding magnetic-layer patterns of a master disk;

FIGS. 8A and 8B are graphs that show regenerative signals of a slave disk;

FIG. 9 is a table that shows the relation of design L width to L/S ratio and wavelength;

FIG. 10 is a graph that shows the relation of design L width to L/S ratio and wavelength;

FIG. 11 is a graph that shows the relation of output to L/S ratio and wavelength;

FIG. 12 is a graph that shows the relation of p-p signal variations to L/S ratio and wavelength;

FIG. 13 is a graph that shows the relation of front waveform irregularity strength to L/S ratio and wavelength;

FIG. 14 is a graph to explain the relationship between the radius position and L/S ratio of a master disk;

FIG. 15 is a conceptual diagram that shows the land L width and L/S ratio in outer circumferential and inner circumferential portions of a master disk;

FIGS. 16A to 16D are partially enlarged sectional views of master disks of other constructions;

FIGS. 17A and 17B are partially enlarged views that show protruding magnetic-layer patterns of a master disk in a conventional example; and

FIGS. 18A to 18C are graphs that show regenerative signals of a slave disk in a conventional example;

### DETAILED DESCRIPTION OF THE PREFERRED EMBODIMENTS

Referring to the accompanying drawings, a detailed description will be given below of preferred embodiments of a master medium for perpendicular magnetic transfer, a method of perpendicular magnetic transfer, a perpendicular magnetic recording medium and a perpendicular magnetic recording apparatus that are related to the present invention.

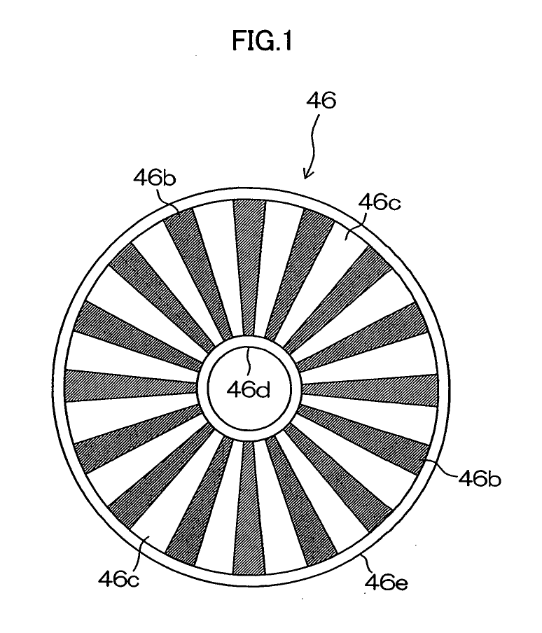

FIG. 1 is a plan view of a master disk for perpendicular magnetic transfer 46. FIG. 2 is a partially enlarged perspective view that shows fine protruding patterns on a surface of the master disk 46. Incidentally, FIG. 2 is a schematic diagram and the size of each part is shown at ratios different from actual ones.

As shown in FIG. 1, the master disk 46 is formed in the shape of a disk, and in a radially middle circumferential portion of the master disk 46 (the portion except an inner circumferential portion 46d and an outer circumferential portion 46e of the master disk 46), servo districts 46b indicated by hatching and non-servo districts 46c (nonhatched portions) are alternately formed circumferentially.

The servo district 46b is an area where magnetic patterns (servo information patterns) are formed, and the non-servo district 46c is an area where magnetic patterns (servo information patterns) are not formed.

Although the master disk 46 is in the form of a circular ring (a donut) having an inside diameter, the master disk may be a disk-like one having no inside diameter.

FIG. 2 is a partially enlarged perspective view of the servo district 46b. On one surface of a substrate 47 there is formed a transfer-information carrying surface on which fine protruding patterns by magnetic layer 48 are formed, and a surface on the opposite side of the substrate 47 is held by a close contacting device that is not shown in the figure. The formation of the fine protruding patterns is performed by the photofabrication method and the like, which will be described later. This surface (transfer-information carrying surface) of the master disk 46 is a surface that is brought into close contact with a slave disk 40.

The fine protruding pattern is rectangular as viewed on a plane and consists of a length b in the track direction (the direction indicated by a thick arrow in the figure) and a radial length l, with the magnetic layer 48 of a step t formed. Optimum values of the lengths b and l depend on recording density, recording signal waveform and the like. For example, the length b can be set at 80 nm and the length l can be set at 200 nm.

The fine protruding patterns are formed radially long in the case of servo signals. In this case, it is preferred that the radial length l be, for example, 0.05 to 20 μm and that the length in the track direction (the circumferential direction) b be, for example, 0.03 to 5 μm. It is preferable to select a pattern having a larger radial length in these ranges as a pattern that carries servo signal information.

The step t of the fine protruding patterns on the surface of the substrate 27 is preferably in the range of 30 to 200 nm and the thickness of the whole magnetic layer 48 is preferably in the range of 40 to 250 nm.

When in the master disk 46, the substrate 47 is made of a ferromagnetic material containing mainly Ni and the like, magnetic transfer is possible with this substrate 47 alone and it is not always necessary to form the magnetic layer 48. However, by providing a magnetic layer 48 having good transfer characteristics, better magnetic transfer can be performed. When the substrate 47 is made of a nonmagnetic material, it is necessary that the magnetic layer 48 be provided. It is preferred that the magnetic layer 48 of the master disk 46 be made of a soft magnetic layer having a coercivity Hc of not more than 48 kA/m (≅600 Oe).

As materials for the substrate 47 of the master disk 46, it is possible to use nickel, silicon, glasses of various compositions such as quartz glass, aluminum, alloys, ceramics of various compositions, synthetic resins and the like. However, in the case of synthetic resins, it is necessary that the synthetic resins be made of materials whose properties do not change due to a resist separation liquid in the lift-off step, which will be described later, or it is necessary to make some contrivance to ensure that the properties of the synthetic resins do not change due to a resist separation liquid (for example, to apply a protective coat).

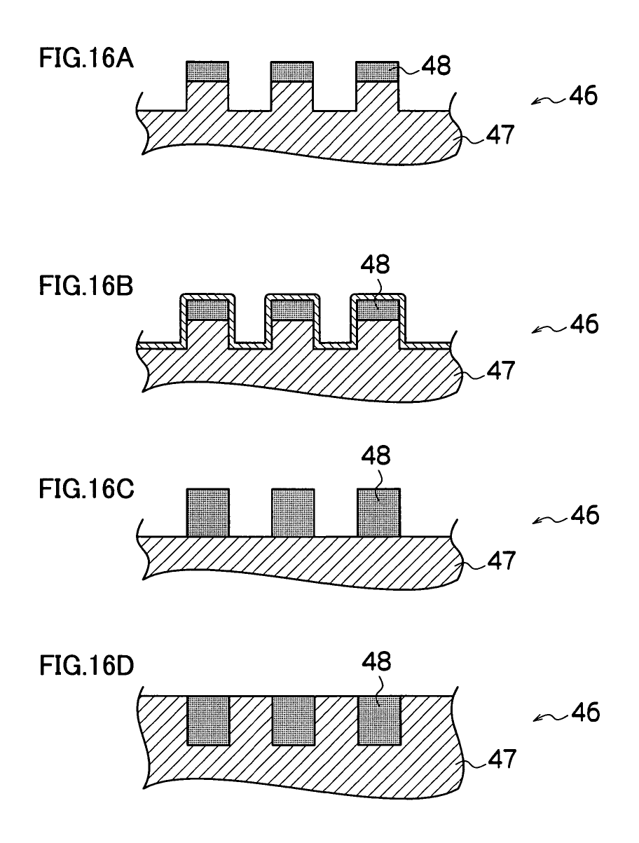

The formation of the concavo-convex patterns on the surface of the substrate 47 (in the case of FIGS. 16A, 166B or 16D, which will be described later) can be performed by the photofabrication method, the stamper method by use of an original disk formed by the photofabrication method and the like, etc.

The formation of an original disk by the stamper method can be performed, for example, as follows. A layer of a photoresist is formed by the spin coat method and the like on a glass plate (or a quartz glass plate) having a smooth surface, after pre-baking this glass plate is irradiated with laser beams (or electron beams) modulated to adapt to a servo signal while the glass plate is being rotated, whereby substantially on the whole surface of the photoresist layer, prescribed patterns, for example, patterns that correspond to the servo signal and extend linearly in the radial direction from the center of rotation in each track are exposed to portions corresponding to each frame on the circumference.

After that, the photoresist layer is subjected to development treatment and an original disk of glass having the concavo-convex shape formed by the photoresist layer from which the exposed portions have been removed is obtained. Subsequently, on the basis of the concavo-convex patterns on the surface of the original disk of glass, this surface is plated (electroformed) and formation to a prescribed thickness is performed, whereby a Ni substrate having positive concavo-convex patterns on a surface thereof is prepared. And this substrate is separated from the original disk of glass.

This substrate is used as an original disk of press without any further treatment or this substrate is used as an original disk of press after the coating of the concavo-convex patterns with a soft magnetic layer, a protective layer, etc. as required.

Or alternatively, it is possible to adopt a method that involves plating an original disk of glass, preparing a second original disk by electroforming, and further plating this second original disk, whereby a reverse original disk having negative concavo-convex patterns are prepared by electroforming. Furthermore, it is also possible to adopt a method that involves preparing a third original disk either by plating and electroforming the second original disk or by pushing a low-viscosity resin against the second original disk and hardening the resin, and plating and electroforming the third original disk, whereby a substrate having positive concavo-convex patterns is prepared.

On the other hand, the formation of an original disk by the photofabrication method can be performed, for example, as follows. A layer of a photoresist is formed by the spin coat method and the like on a smooth surface of a flat-plate-like substrate, after pre-baking this glass plate is irradiated with laser beams (or electron beams) modulated to adapt to a servo signal while the glass plate is being rotated, whereby substantially on the whole surface of the photoresist layer, prescribed patterns, for example, patterns that correspond to the servo signal and extend linearly in the radial direction from the center of rotation in each track are exposed to portions corresponding to each frame on the circumference.

After that, the photoresist layer is subjected to development treatment and a substrate having the concavo-convex shape formed by the photoresist layer from which the exposed portions have been removed is obtained. The substrate after the development treatment is post-baked and the adhesion of the photoresist to the substrate is increased thereby.

Subsequently, the etching of the substrate is performed in the etching step and holes corresponding to the concavo-convex patterns are formed. Subsequently, the photoresist is removed and the surface is made smooth. As a result of this, an original disk having the concavo-convex shape is obtained.

Subsequently, after the application of conductive layers to the surfaces of the concavo-convex patterns on the surface of the original disk, plating (electroforming) is performed and the concavo-convex patterns are formed to a prescribed thickness, whereby a Ni substrate having negative concavo-convex patterns on the surface thereof is fabricated. And this substrate is separated from the original disk.

Ni or Ni alloys can be used as metal materials for a substrate and an original disk by electroforming. Electroless plating, electroforming, sputtering, various kinds of metal film formation processes including ionplating, etc. can be applied as plating methods for preparing this substrate.

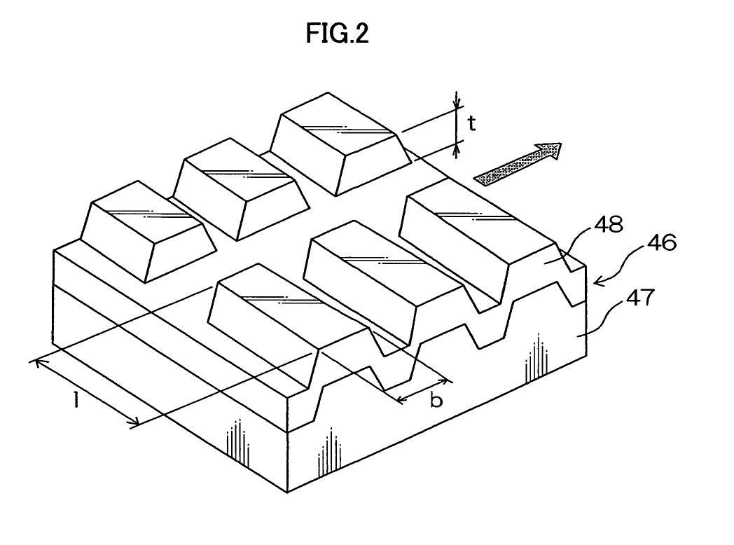

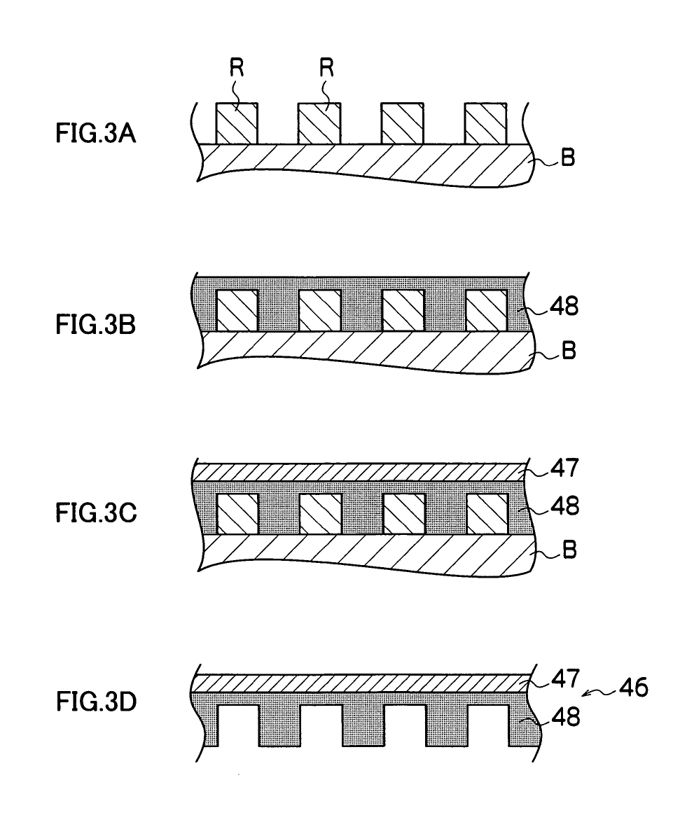

Next, referring to FIGS. 3A to 3D, a description will be given of a concrete method of forming the master disk 46 suitable for perpendicular magnetic recording, which is shown in FIG. 2 previously described.

First, as shown in FIG. 3A, a photoresist layer is formed by the spin coat method and the like on a smooth surface of a flat substrate B, after pre-baking this substrate is irradiated with laser beams (or electron beams) modulated to adapt to a servo signal while the substrate is being rotated, whereby substantially on the whole surface of the photoresist layer, prescribed patterns, for example, patterns that correspond to the servo signal and extend linearly in the radial direction from the center of rotation in each track are exposed to portions corresponding to each frame on the circumference.

After that, the photoresist layer is subjected to development treatment and a substrate having the concavo-convex shape formed by photoresist layers R, R . . . from which the exposed portions have been removed is obtained. The substrate after the development treatment is post-baked and the adhesion of the photoresist layers R, R . . . to the substrate is increased thereby. Incidentally, although in a usual process, an etching step by RIE is performed at this stage, the illustration and detailed description of the etching step are omitted.

Subsequently, as shown in FIG. 3B, a magnetic material is deposited on a front surface (the top surface) of the substrate B and a magnetic layer 48 is formed. In the formation of the magnetic layer 48 (a soft magnetic layer), a film is formed from a magnetic material by a vacuum film forming device, which uses the vacuum evaporation method, the sputtering method and the ionplating method, plating methods and the like.

As magnetic materials for the magnetic layer 48, it is possible to use Co, Co alloys (CoNi, CoNiZr, CoNbTaZr, etc.), Fe, Fe alloys (FeCo, FeCoNi, FeNiMo, FeAlSi, FeAl, FeTaN), Ni, and Ni alloys (NiFe). In particular, FeCo and FeCoNi can be advantageously used.

Subsequently, as shown in FIG. 3C, a substrate material is deposited on a rear surface (the top surface) of the magnetic layer 48 in a prescribed thickness by the plating method and the like and a substrate 47 having a prescribed mechanical strength is formed. As materials for the substrate 47, Ni or Ni alloys are preferable, and the thickness of the substrate 47 is preferably 150 μm or so. As a result of this, a master disk 46 is formed.

Subsequently, as shown in FIG. 3D, the master disk 46 is separated from the substrate B.

After the separation, a magnetic layer (a layer having same composition to the conductive layers) is preferably deposited again on the separation surface (the surface of conductive layers side) with a thickness of 5 to 150 nm (preferably 10 to 100 nm), then a protective layer (protective film) is applied as described below. Although magnetic transfer can be achieved without the additional magnetic layer, the additional magnetic layer provides advantageous effects.

Specifically, it is preferred that a protective film of diamond-like carbon etc. be provided on the magnetic layer 48 of the master disk 46, and a lubricant layer may be further provided on the protective film. In this case, a preferred film construction is a sputter carbon film having a thickness of 5 to 30 nm as the protective film plus a lubricant layer. Also, an adhesion enforcing layer of Si etc. may be provided between the magnetic layer 48 and the protective film. A lubricant is effective in improving the deterioration of durability, such as the occurrence of flaws due to friction during the correction of misalignment which occurs in the process of contact with the slave disk 40.

Next, the slave disk 40, which is a disk targeted for transfer, will be described. The slave disk 40 is a magnetic recording medium in the shape of a disk, such as a hard disk and a flexible disk on both surfaces or one surface of which magnetic recording layers are formed, and before being brought into close contact with the master disk 46, the slave disk 40 is subjected to cleaning treatment (burnishing etc.) as required to remove very minute protrusions or adhering dust on the surface by use of a glide head, an abrasive object, etc. Also, the slave disk 40 is subjected to initial magnetization beforehand. Details of the initial magnetization will be given later.

As the slave disk 40, magnetic recording media in the shape of a disk, such as a hard disk and a high density flexible disk, can be used. As the magnetic recording layer of the slave disk 40, it is possible to adopt an application type magnetic recording layer, a plating type magnetic recording layer or a magnetic recording layer of thin metal film type.

As magnetic materials for the magnetic recording layer of thin metal film type, it is possible to use Co, Co alloys (CoPtCr, CoCr, CoPtCrTa, CoPtCrNbTa, CoCrB, CoNi, etc.), Fe, and Fe alloys (FeCO, FePt, FeCoNi). These permit clear transfer and hence are preferable, because they have large magnetic flux densities and magnetic anisotropy in the same direction as the direction of magnetic field application (the perpendicular direction in the case of perpendicular magnetic recording).

To impart necessary magnetic anisotropy to under the magnetic material (the support medium side), it is preferable to provide a nonmagnetic base layer. It is necessary that the crystal structure and lattice constant of this base layer be adapted to the magnetic layer. For this purpose, it is preferable to use Ti, Cr, CrTi, CoCr, CrTa, CrMo, NiAl, Ru, Pd etc.

Furthermore, to stabilize the perpendicularly magnetized condition of the magnetic recording layer and to improve the sensitivity during writing and reading, it is preferred that a backing layer formed from a soft magnetic layer be further provided under the nonmagnetic base layer.

Incidentally, the thickness of the magnetic recording layer is preferably 10 nm to 500 nm, more preferably 20 nm to 200 nm. The thickness of the magnetic recording layer is preferably 10 nm to 150 nm, more preferably 20 nm to 80 nm. And the thickness of the backing layer is preferably 50 nm to 2000 nm, more preferably 80 nm to 400 nm.

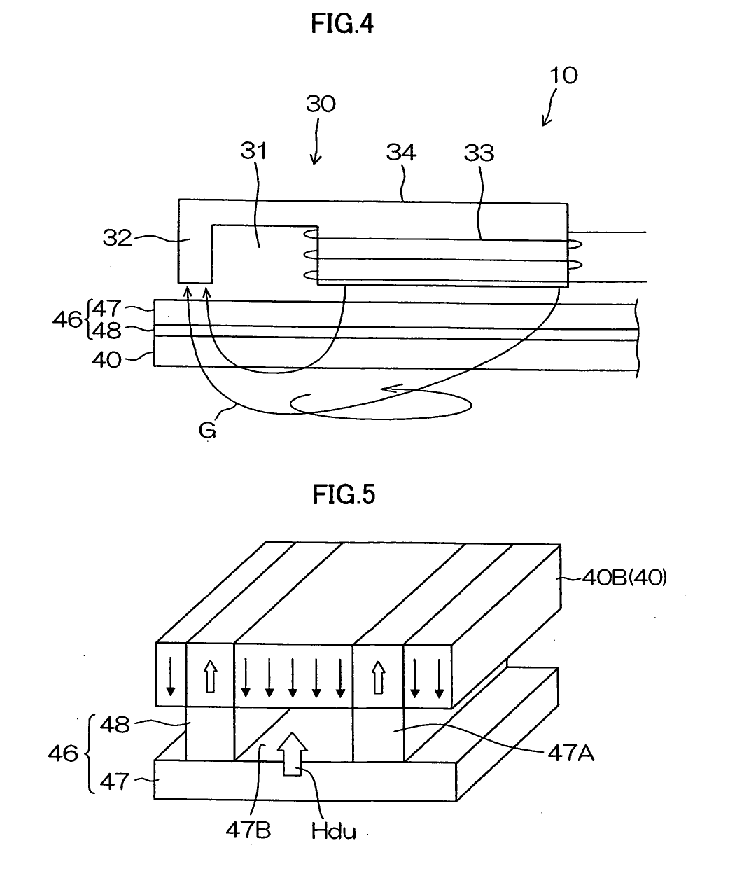

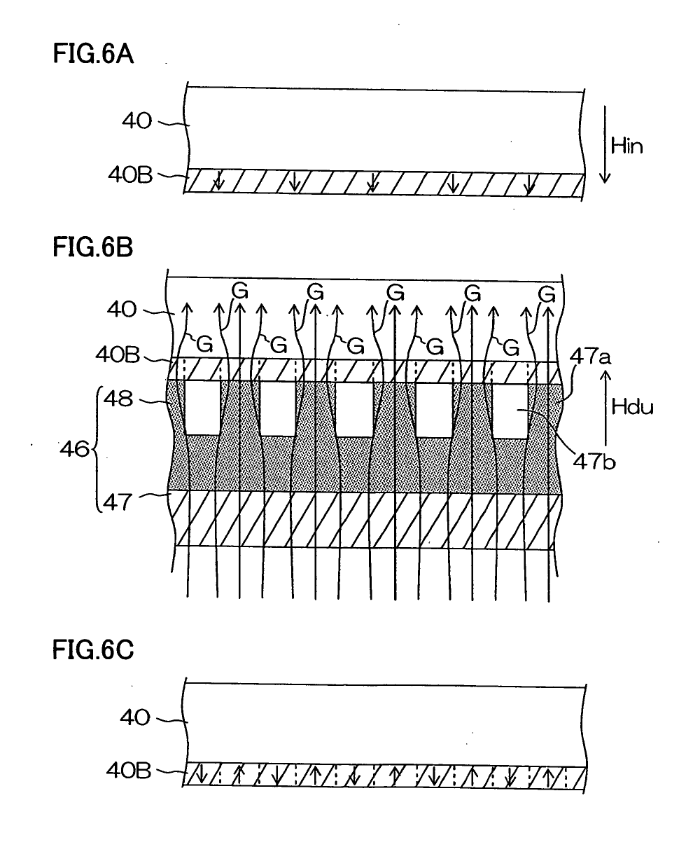

Next, a description will be given of a method of magnetic transfer for transferring the magnetic layer patterns of the master disk 46 to the slave disk 40, which is a disk targeted for transfer. FIG. 4 is a partial front view of a magnetic transfer apparatus 10 for carrying out magnetic transfer by use of the master disk 46 related to the present invention. FIG. 5 is a perspective view to explain an outline of a method of magnetic transfer. FIGS. 6A to 6C are sectionals view to explain basic steps of magnetic transfer.

In the magnetic transfer apparatus 10, it is ensured that during magnetic transfer, a slave surface (a magnetic recording surface) of the slave disk 40 after the initial DC magnetization of FIG. 6A, which will be described later, can be brought into contact with the information carrying surface of the master disk 46 and then brought into close contact therewith a prescribed pressing force. And it is ensured that with the slave disk 40 and the master disk 46 kept in a close contact condition, magnetization patterns of servo signal etc. can be transferred and recorded by applying magnetic fields for transfer by use of a magnetic field generating device 30.

There are two methods of performing magnetic transfer by use of the master disk 46. In one method, as shown in FIG. 4, with the master disk 46 in close contact with one surface of the slave disk 40, transfer is sequentially performed on one surface and in the other method, with the master disks 46, 46 in close contact with both surfaces of the slave disk 40, simultaneous transfer is performed on both surfaces. Incidentally, before the master disk 46 is brought into close contact with the slave disk 40, the master disk 46 is subjected to cleaning treatment as required to remove adhering dust.

The magnetic field generating device 30 that applies magnetic fields for transfer is constituted by an electromagnet device 34 that is disposed on the upper side of the magnetic field generating device 30. In the electromagnet device 34, a coil 33 is wound around a core 32 that has a gap 31 extending in the direction of the radius of the slave disk 40 and master disk 46 held by a close contacting device so that magnetic fields for transfer having lines of magnetic force G perpendicular to the track direction can be applied.

A rotary device is provided so that magnetic fields for transfer can be applied by the magnetic field generating device 30 while the slave disk 40 and the master disk 46 are being rotated as one piece and the transfer information of the master disk 46 can be magnetically transferred and recorded on the slave surface of the slave disk 40. Incidentally, in addition to this construction, it is also possible to adopt a construction in which the magnetic field generating device 30 is provided so as to be rotationally moved.

The basic steps of magnetic transfer are shown in FIGS. 6A to 6C. FIG. 6A shows a step of applying magnetic fields in one direction, thereby to perform the initial DC magnetization of the slave disk 40, FIG. 6B shows a step of bringing the master disk 46 and the slave disk 40 into close contact with each other, thereby to apply magnetic fields in a direction reverse to initial DC magnetic fields, and FIG. 6C shows the condition after magnetic transfer. For the slave disk 40, only a magnetic recording layer 40B on the lower side of the slave disk 40 is shown. Incidentally, each of the drawings is a schematic diagram and the size of each part is shown at ratios different from actual ones.

As shown in FIG. 6A, initial DC magnetic fields Hin are beforehand applied to the slave disk 40 in one direction perpendicular to the track surface, whereby the magnetization of the magnetic recording layer 40B is performed as initial DC magnetization. As shown in FIGS. 5 and 6B, with the surface of the slave disk 40 on the magnetic recording layer 40B side and the surface of the slave disk 46 on the magnetic layer 48 side brought into close contact with each other, magnetic fields for transfer Hdu in a direction reverse to the initial DC magnetic fields Hin are applied in a direction perpendicular to the track surface of the slave disk 40, whereby magnetic transfer is performed.

As a result, as shown in FIGS. 5 and 6C, information (for example, a servo signal) corresponding to protruding patterns 47A, 47A . . . of the master disk 46 is magnetically transferred and recorded to the magnetic recording layer 40B of the slave disk 40.

In FIGS. 6A to 6C, the description was given of magnetic transfer to the magnetic recording layer 40B on the lower side of the slave disk 40 by the master disk 46 on the lower side. However, it is also possible to perform magnetic transfer, simultaneously with the magnetic recording layer on the lower side, to the magnetic recording layer on the upper side of the slave disk 40 in the same manner as with the magnetic recording layer on the lower side by bringing the master disk 46 into close contact with the upper side of the slave disk 40.

Furthermore, even when the concavo-convex patterns (protruding patterns 47A and concave portions 47B) of the master disk 46 are negative concavo-convex patterns reverse to the positive patterns of FIG. 6B, similar information can be magnetically transferred and recorded by reversing the direction of the initial magnetic fields Hin and the direction of the magnetic fields for transfer Hdu, which are described above.

Incidentally, for the initial magnetic fields and the magnetic fields for transfer, it is necessary to adopt values determined in consideration of the coercivity of the slave disk 40, the specific magnetic permeability of the master disk 46 and the slave disk 40 and the like.

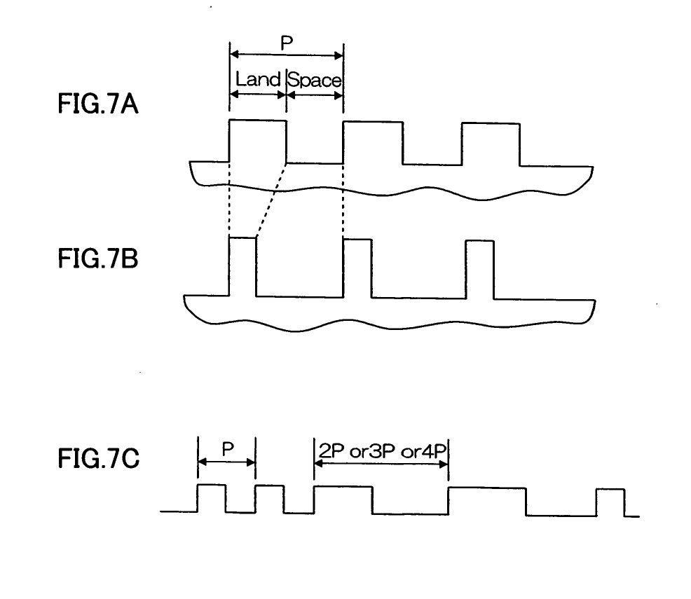

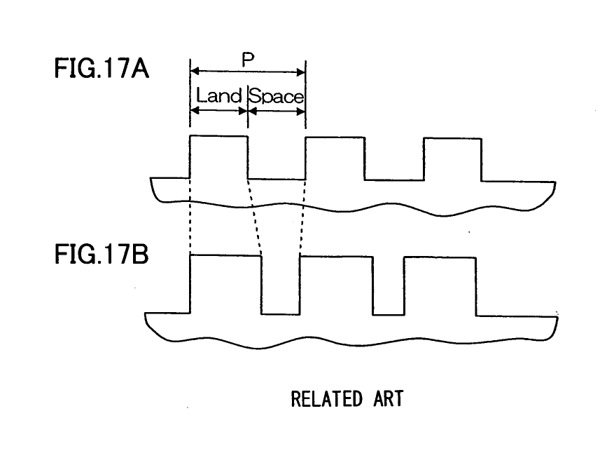

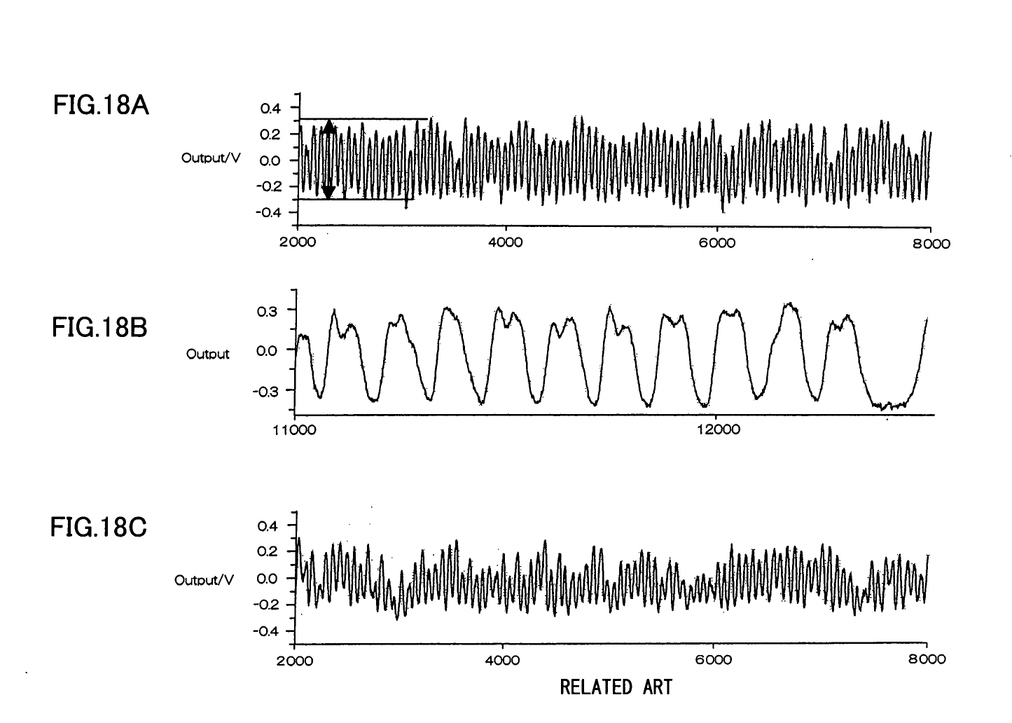

Next, a description will be given of the L/S ratio of the concavo-convex patterns of the master disk 46, which constitutes one of the features of the present invention. FIGS. 7A to 7C are partially enlarged views that show protruding magnetic-layer patterns of the master disk 46 and correspond to FIGS. 17A and 17B, which are described above.

As shown in FIG. 7A, the land (L) and spaces (S) of the protruding patterns are alternately formed on a surface of the master disk 46. And in the case of the master disk 46 for perpendicular magnetic recording of the present invention, as shown in FIG. 7B, it is necessary that the master disk 46 be formed to provide L/S ratios of less than 1. Incidentally, FIG. 7C will be described later.

As an especially preferable L/S ratio, the relation of the circumferential width L of the protruding magnetic-layer patterns to the fundamental frequency f of information to be transferred is given by L=305−302×Exp(−1/(700·f)) and the ratio of the width L to the circumferential gap S between the protruding magnetic-layer patterns is (⅓)≦L/S<1. And it is preferred that the center value, which is the width L, be within 2% of the wavelength.

The above-described ratio L/S is the relation L/S=(design land L width)/(wavelength−design land L width).

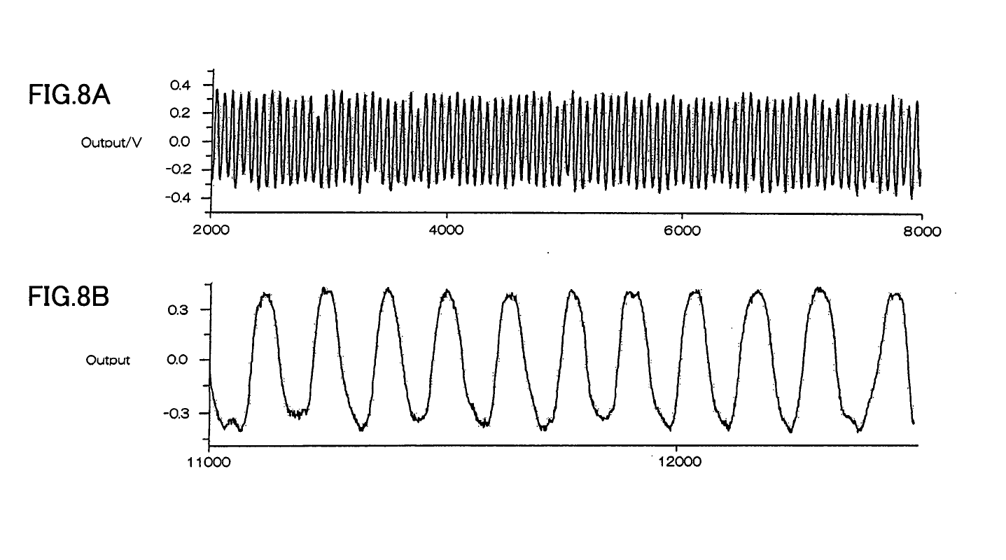

FIGS. 8A and 8B are graphs that show regenerative signals of the slave disk when perpendicular magnetic transfer is performed by using a master disk having an L/S ratio as shown in FIG. 7B. FIG. 8A shows regenerative signals in the middle circumferential portion of the slave disk and FIG. 8B is a graph with an enlarged scale of FIG. 8A in the X-direction.

As can be seen from each of the graphs of FIGS. 8A and 8B, in a case where a master disk having an L/S ratio as shown in FIG. 7B is used, among the above-described problems, the problem 1) of an irregularity at the front of waveform and the problem 2) of large modulation are resolved.

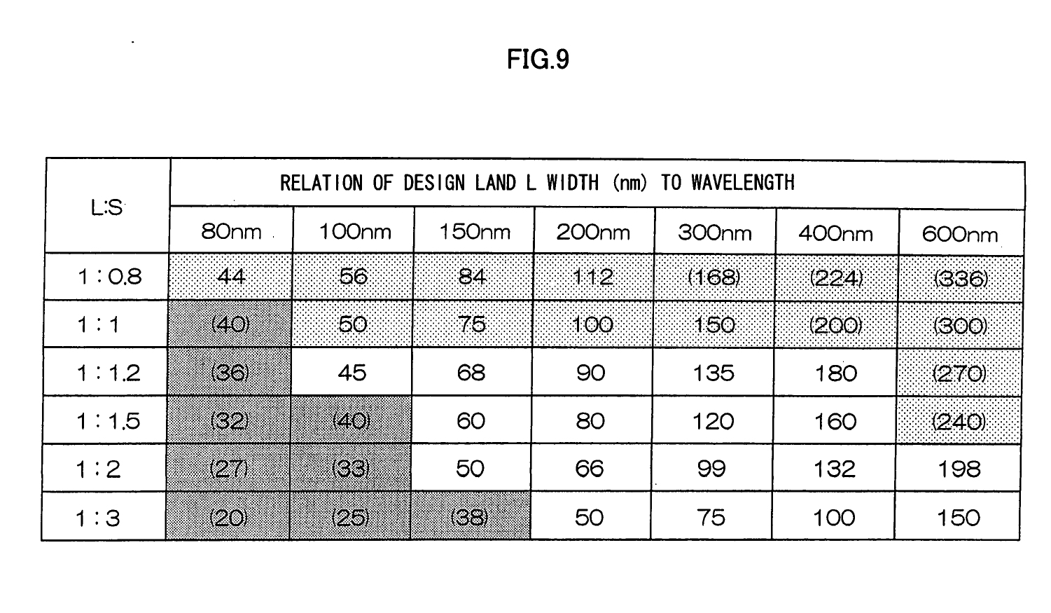

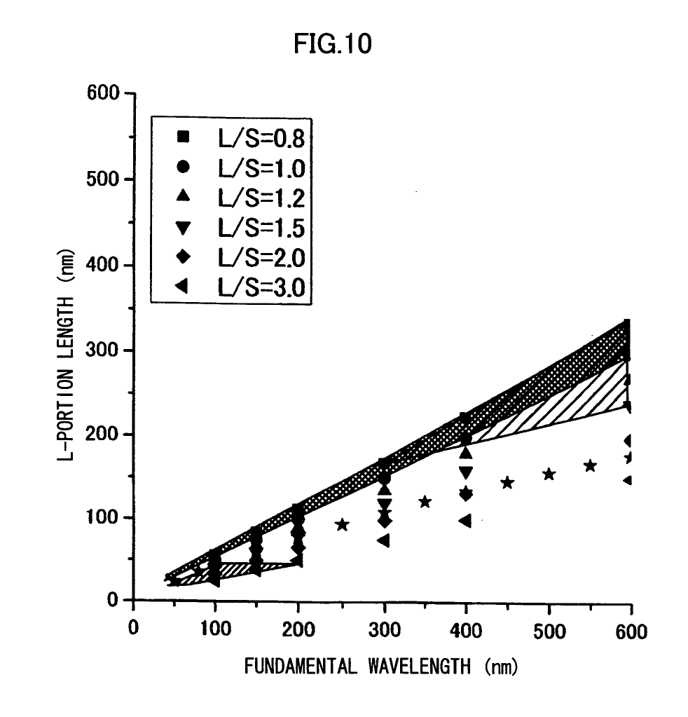

Next, the relation of the design land L width to the ratio L/S and waveform is calculated and the result is shown in the table of FIG. 9 and the X-Y graph of FIG. 10. Incidentally, in the graph of FIG. 10, the star sign indicates design land L width.

In the table of FIG. 9, the upper two sections show conditions of L/S of not less than 1, the upper right gray portions (where the numerals are in parentheses) show the conditions under which cracks occur at the front of the waveform, and the lower left gray portions (where the numerals are in parentheses) show the conditions under which microfabrication accuracy is required. These are all undesirable ranges. And in the table of FIG. 9, the uncolored portions that are desirable ranges. Incidentally, the lower left gray portions (where the numerals are in parentheses) can vary as microfabrication technology is improved.

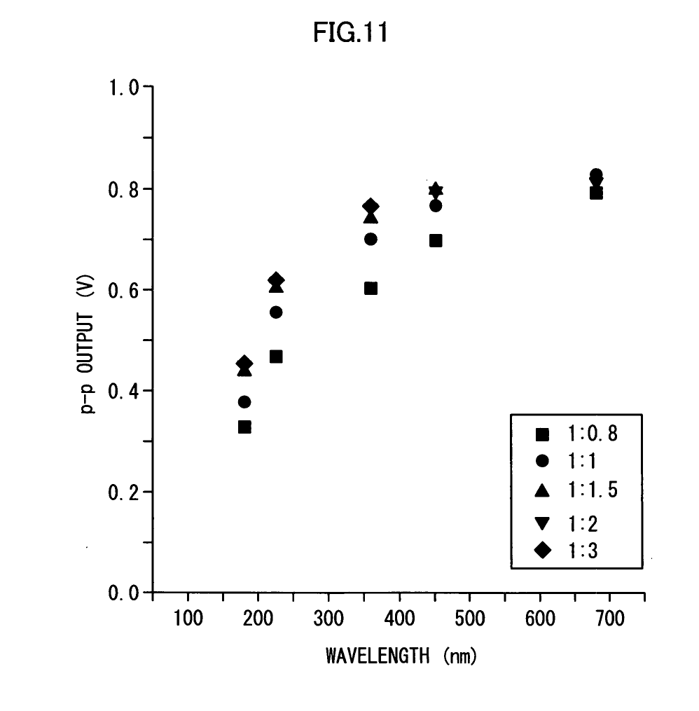

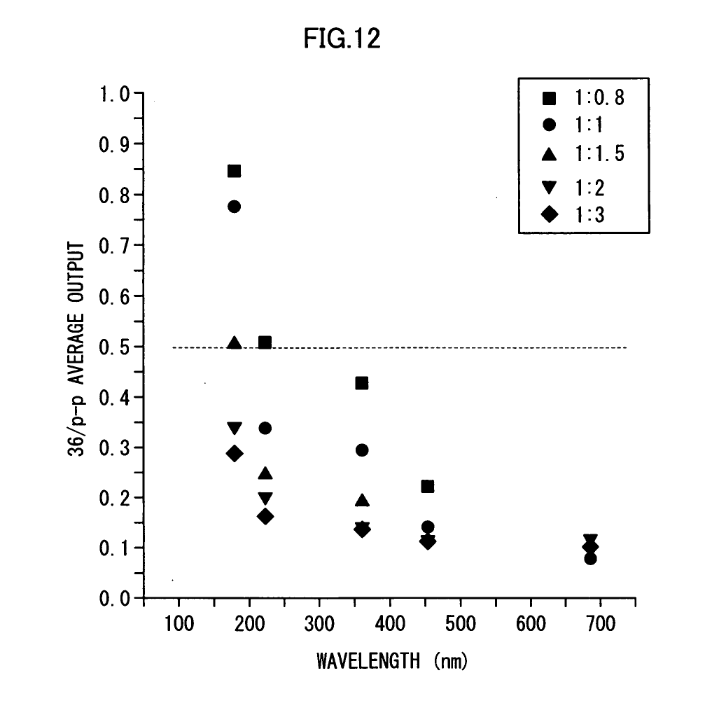

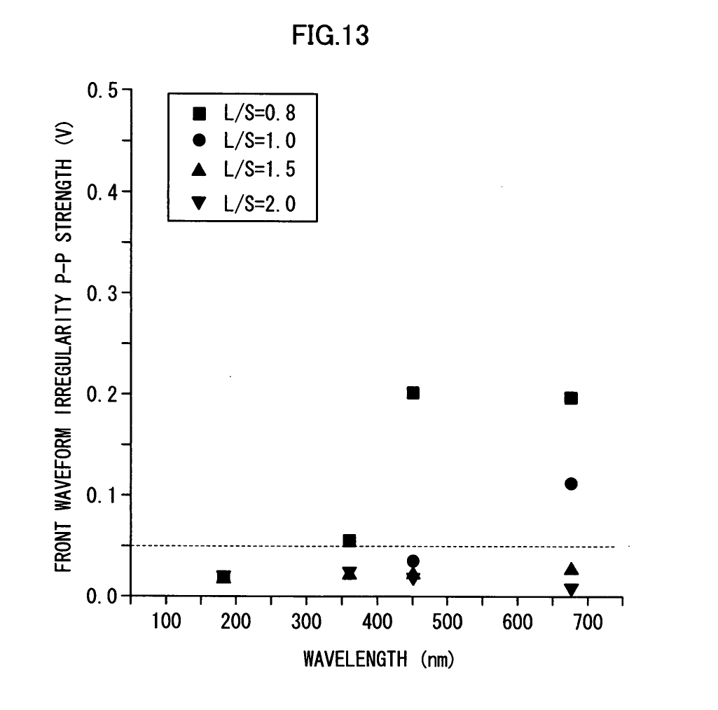

Hereinafter, similarly is shown data on the effect obtained by L/S ratios of less than 1. FIG. 11 is an X-Y graph that shows the relation of output to L/S ratio and wavelength. FIG. 12 is an X-Y graph that shows the relation of p-p signal variations to L/S ratio and wavelength. And FIG. 13 is an X-Y graph that shows the relation of front waveform irregularity strength to L/S ratio and wavelength.

From any of the graphs of FIG. 11 to 13, it is apparent that good results are obtained by setting the L/S ratio at less than 1.

Next, the relationship between wavelength and a desirable L/S ratio will be described. FIG. 7C, which has already been described, shows a case where the master disk 46 is formed so as to provide different values of the ratio L/S according to the frequency of the information to be transferred in the same radial position of the master disk 46. If the master disk 46 can be formed so as to provide an optimum ratio L/S according to the frequency (1/p) like this, it is possible to perform still better magnetic transfer.

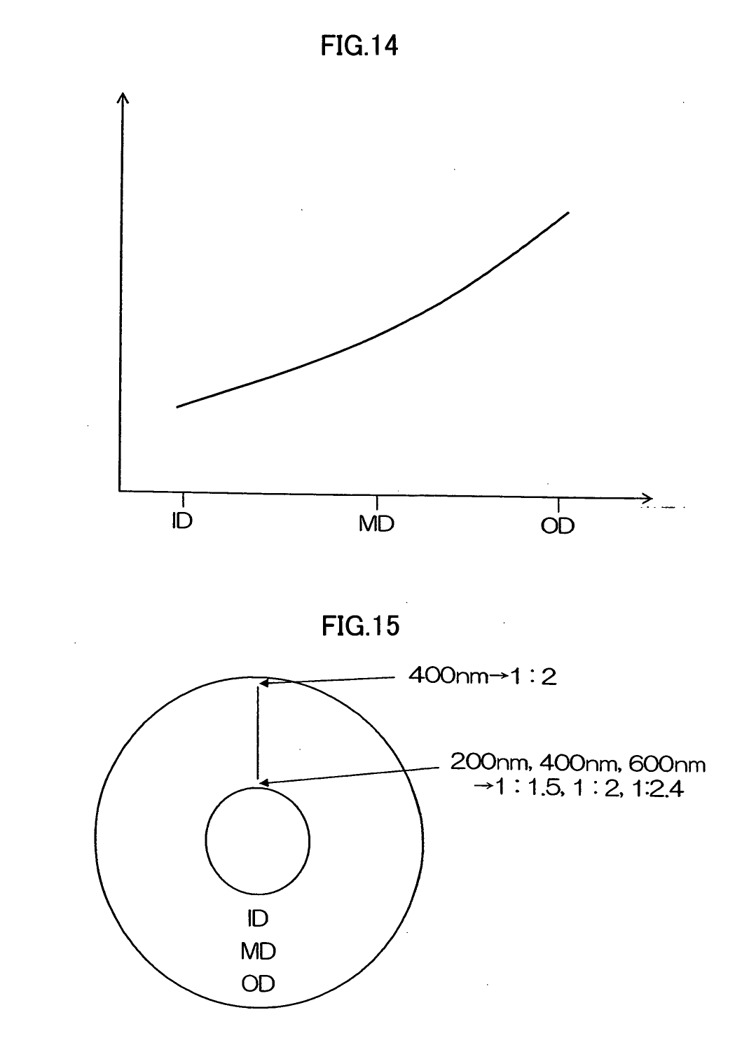

Next, a description will be given of the relationship between the radial position of the master disk 46 and a desirable L/S ratio. FIG. 14 is an X-Y graph to explain the relationship between the radius position and L/S ratio of the master disk 46. FIG. 15 is a conceptual diagram that shows the land L width and L/S ratio in outer circumferential (OD) and inner circumferential (ID) portions of the master disk 46.

If the master disk 46 can be formed so as to provide an optimum ratio L/S according to the radial position of the master disk 46 like this, it is possible to perform still better magnetic transfer and it is possible to resolve the problem 3) of a decrease in signal intensity in the inner circumferential portion.

As described above, according to a master medium for perpendicular magnetic transfer (master disk 46) and a method of perpendicular magnetic transfer related to the present invention, it is possible to perform good magnetic transfer and to obtain a good perpendicular recording medium (slave disk 40).

A slave disk 40 on which magnetic transfer has been performed can be advantageously used by being incorporated into a magnetic recording device (hard disk drive). Publicly known various devices sold by various drive makers can be used as the hard disk drive used in this slave disk.

Although descriptions were given above of embodiments of a master medium for perpendicular magnetic transfer, a method of perpendicular magnetic transfer, a perpendicular magnetic recording medium and a perpendicular magnetic recording apparatus that are related to the present invention, the present invention is not limited to the above-described embodiments and various embodiments can be adopted.

For example, in this embodiment, the master disk 46 of the construction of FIG. 2 fabricated by the process of FIGS. 3A to 3C is shown. However, master disks of other constructions may be used. FIGS. 16A to 16D are partially enlarged sectional views of master disks 46 of other constructions.

In the master disk of FIG. 16A, protruding patterns are formed on the surface of the substrate 47 and the magnetic layer 48 is formed only on the protruding patterns.

In the master disk of FIG. 16B, protruding patterns are formed on the surface of the substrate 47, and the magnetic layer 48 is formed not only on the protruding patterns, but also on the whole surface of the substrate 47.

In the master disk of FIG. 16C, a magnetic layer 48 of protruding patterns is formed on a flat surface of the substrate 47.

In the master disk of FIG. 16D, concave portions are formed on a flat surface of the substrate 47, and magnetic layers 48 are buried in the concave portions so that the surface of the substrate 47 is formed flush.

Also, as already described, the master disk 46 is in the shape of a circular ring (donut) having an inside diameter. However, the master disk 46 may be in the form of a disk having no inside diameter.

In this embodiment, the magnetic field generating device 30 is such that the electromagnet device 34 is disposed on the upper side of the slave disk 40 and the master disk 46. However, in place of this construction, it is possible to adopt a construction in which magnetic fields are applied by disposing magnet devices (bar magnets) on both sides of the slave disk 40 and the master disk 46. Furthermore, both an electromagnet and a permanent magnet may be used as the magnetic device.

What is claimed is:

1. A master medium for perpendicular magnetic transfer, comprising:
a disk-like substrate on a surface of which a plurality of protruding magnetic-layer patterns corresponding to information to be transferred to a magnetic recording medium targeted for transfer are formed,
wherein a ratio of a circumferential width L of the protruding magnetic-layer patterns to a circumferential gap S between the protruding magnetic-layer patterns is L/S<1.

2. The master medium for perpendicular magnetic transfer according to claim 1, wherein the master medium for perpendicular magnetic transfer is formed so as to provide different values of the ratio L/S according to the frequency of the information to be transferred in the same radial position of the substrate.

3. A master medium for perpendicular magnetic transfer, comprising:
a disk-like substrate on a surface of which a plurality of protruding magnetic-layer patterns corresponding to information to be transferred to a magnetic recording medium targeted for transfer are formed,
wherein a relation of a circumferential width L of the protruding magnetic-layer patterns to a fundamental frequency f of an information to be transferred is expressed by L=305−302·Exp(−1/(700·f)) and a ratio of a width L to a circumferential gap S between the protruding magnetic-layer patterns is (⅓)≦L/S<1.

4. The master medium for perpendicular magnetic transfer according to claim 3, wherein the master medium for perpendicular magnetic transfer is formed so as to provide different values of the ratio L/S according to the frequency of the information to be transferred in the same radial position of the substrate.

5. A method of perpendicular magnetic transfer, comprising:
a close contacting step of bringing the master medium for perpendicular magnetic transfer according to claim 1 into close contact with the magnetic recording medium targeted for transfer; and
a magnetic transfer step of providing a magnetic field generating device, applying magnetic fields perpendicular to surfaces of the magnetic recording medium targeted for magnetic transfer and of the master medium for perpendicular magnetic transfer, and causing the magnetic patterns of the master medium for perpendicular magnetic transfer to be transferred to the magnetic recording medium targeted for transfer.

6. A method of perpendicular magnetic transfer, comprising:
a close contacting step of bringing the master medium for perpendicular magnetic transfer according to claim 2 into close contact with the magnetic recording medium targeted for transfer; and
a magnetic transfer step of providing a magnetic field generating device, applying magnetic fields perpendicular to surfaces of the magnetic recording medium targeted for magnetic transfer and of the master medium for perpendicular magnetic transfer, and causing the magnetic patterns of the master medium for perpendicular magnetic transfer to be transferred to the magnetic recording medium targeted for transfer.

7. A method of perpendicular magnetic transfer, comprising:
a close contacting step of bringing the master medium for perpendicular magnetic transfer according to claim 3 into close contact with the magnetic recording medium targeted for transfer; and
a magnetic transfer step of providing a magnetic field generating device, applying magnetic fields perpendicular to surfaces of the magnetic recording medium targeted for magnetic transfer and of the master medium for perpendicular magnetic transfer, and causing the magnetic patterns of the master medium for perpendicular magnetic transfer to be transferred to the magnetic recording medium targeted for transfer.

8. A method of perpendicular magnetic transfer, comprising:
a close contacting step of bringing the master medium for perpendicular magnetic transfer according to claim 4 into close contact with the magnetic recording medium targeted for transfer; and
a magnetic transfer step of providing a magnetic field generating device, applying magnetic fields perpendicular to surfaces of the magnetic recording medium targeted for magnetic transfer and of the master medium for perpendicular magnetic transfer, and causing the magnetic patterns of the master medium for perpendicular magnetic transfer to be transferred to the magnetic recording medium targeted for transfer.

9. A perpendicular magnetic recording medium, wherein information to be transferred is recorded by the method of perpendicular magnetic transfer according to claim 5.

10. A perpendicular magnetic recording medium, wherein information to be transferred is recorded by the method of perpendicular magnetic transfer according to claim 8.

11. A perpendicular magnetic recording apparatus, comprising the perpendicular magnetic recording medium according to claim 9.

12. A perpendicular magnetic recording apparatus, comprising the perpendicular magnetic recording medium according to claim 10.
